(19) United States
(12) Patent Application Publication
(10) Pub. No.: US 2017/0075844 A1
(43) Pub. Date: Mar. 16, 2017

(54) COMMUNICATION DEVICE, COMMUNICATION METHOD, AND NON-TRANSITORY COMPUTER READABLE MEDIUM

(71) Applicant: KABUSHIKI KAISHA TOSHIBA, Tokyo (JP)

(72) Inventors: Yuta KOBAYASHI, Kawasaki (JP); Takahiro YAMAURA, Kawasaki (JP); Kensaku YAMAGUCHI, Kawasaki (JP); Takeshi ISHIHARA, Yokohama (JP)

(21) Appl. No.: 15/264,910

(22) Filed: Sep. 14, 2016

(30) Foreign Application Priority Data
Sep. 15, 2015 (JP) 2015-182062

(51) Int. Cl. G06F 13/40; G06F 13/28

(52) U.S. Cl. CPC G06F 13/4027; G06F 13/28

(57) ABSTRACT

In a communication device according to one embodiment, a bridge processor transmits, through the second communication processor, a first data transfer request having been received at the first communication processor and transmits, through the first communication processor, a first response having been received at the second communication processor. A cache proxy processor transmits a second response including the data through the first communication processor when the data is present in a storage device and when the data is not present, receives a third response including data by proxy from the second communication device and transmits a fourth response including the data through the first communication processor. A state acquiring circuit acquires information indicating a state of the storage device. A distribution processor determines which of the bridge processor and the cache proxy processor performs processing related to the first data transfer request according to the state of the storage device.

### CROSS-REFERENCE TO RELATED APPLICATIONS

This application is based upon and claims the benefit of priority from Japanese Patent Application No. 2015-182062, filed Sep. 15, 2015; the entire contents of which are incorporated herein by reference.

### FIELD

Embodiments described herein relate to a communication device, a communication method and a non-transitory computer readable medium.

### BACKGROUND

In recent years, with enriched contents such as video contents, network traffic explosively increases. Such traffic increase will cause the deterioration of communication quality such as low throughput or long delay to an end user due to the network congestion. In other words, there is a problem that network infrastructure costs increase due to enhancing network bandwidth for responding to the increase of network traffic. As one of the solutions for these problems, a method to install a cache proxy server between a communication terminal (client) of the end user and a server is known.

The cache proxy server acquires a data transfer request such as an HTTP GET request which has been issued to the server by the client and issues the data transfer request to the server instead of the client. When the cache proxy server receives a response to the data transfer request, which has been transmitted from the server, the cache proxy server transmits the response to the client and also retains the data included in the response as cache data in a storage device in the cache proxy server. The cache proxy server responds to the client by using the cache data stored in the storage device with respect to a request to the same data from the client which is issued thereafter without issuing a request to the server. According to such operations, the frequently accessed data is responded using the cache data retained in the cache proxy server and it results in providing such effects that traffic can be reduced between the server and the cache proxy server. Moreover, since the operations are not affected by an upper network of the cache server, an effect of high throughput and low latency in communication with the client is also provided.

It is assumed that a communication device arranged near the client terminal, such as a wireless LAN access point, a network switch, a network router or the like, has the cache proxy function mentioned above. This is a more effective method for implementing high throughput and low latency while reducing cost of the upper network. However, this raises a new issue that the communication devices are necessary to mount the storage device which was so far unnecessary. For example, when an access load to the storage device becomes higher, performance of an overall system can be decreased since the storage access becomes a bottleneck. In particular, when an operation log, an error log and the like are stored in the storage device which is shared with the cache data, the response to the client will be delayed as the load of the storage device temporarily increases when a log writing occurs.

Moreover, there is also a problem that the storage device has relatively a short lifetime among components mounted therein. Particularly, lifetime of a NAND storage device such as an SSD, an eMMC or the like, will cause a large problem. From the point of view in product, it is important that an operation as in a conventional communication device is kept at least even when the storage device falls.

In an expensive communication device such as a server, reliability is secured by letting to have redundancy by technologies such as a RAID. While in the communication device such as a wireless LAN access point, mounting a plurality of storage devices becomes disadvantageous in regards to costs (expenses) and the like.

Conventionally, there is a technology that determines whether to carry out cache processing in consideration of a bit rate of contents and a bandwidth of an upper network. However, in this technology, there occur problems that throughput reduces or a response delay time increases since the cache processing is carried out even when an access load to the storage is high or the storage falls. In some cases, there also occurs a problem that an overall system stops.

### BRIEF DESCRIPTION OF THE DRAWINGS

FIG. 1 is a block diagram showing a communication device according to a first embodiment;

FIG. 2 is a flowchart showing operations of the first embodiment;

FIG. 3 is a hardware configuration diagram of a communication device according to a second embodiment;

FIG. 4 is a software configuration diagram of the communication device according to the second embodiment;

FIG. 5 is another software configuration diagram of the communication device according to the second embodiment;

FIG. 6 is another hardware configuration diagram of the communication device according to the second embodiment;

FIG. 7 is a block diagram showing a communication device according to a third embodiment;

FIG. 8 is a flowchart showing operations of the third embodiment; and

FIG. 9 is a hardware configuration diagram of the communication device according to the third embodiment.

### DETAILED DESCRIPTION

According to one embodiment, a communication device including: a first communication processor which communicates with a first communication device; a second communication processor which communicates with a second communication device; and a circuitry system.

The circuitry system includes a bridge processor configured to perform bridge processing which receives a first data transfer request for the second communication device received at the first communication processor to transmit the first data transfer request through the second communication processor, and receives a first response having been received at the second communication processor to transmit the first response through the first communication processor, the first response including data requested by the first data transfer request.

The circuitry system includes a cache proxy processor configured to perform proxy processing which examines whether the data requested by the first data transfer request is present in a storage device, transmits a second response including the data through the first communication processor when the data is present, transmits a second data transfer request which requests transmission of the data for the second communication device through the second communication processor when the data is not present, stores a data included in a third response for the second data transfer request from the second communication device in the storage device and transmits a fourth response including the data through the first communication processor.

The circuitry system includes a state acquiring circuit which acquires information indicating a state of the storage device.

The circuitry system includes a distribution processor which determines, when the first data transfer request is received at the first communication processor, one of the bridge processing and the proxy processing in accordance with the state of the storage device.

the bridge processor performs the bridge processing when the bridge processor is determined and the cache proxy processor performs the proxy processing when the cache proxy processor is determined.

Hereinafter, embodiments of the present invention will be described with reference to the drawings.

### First Embodiment

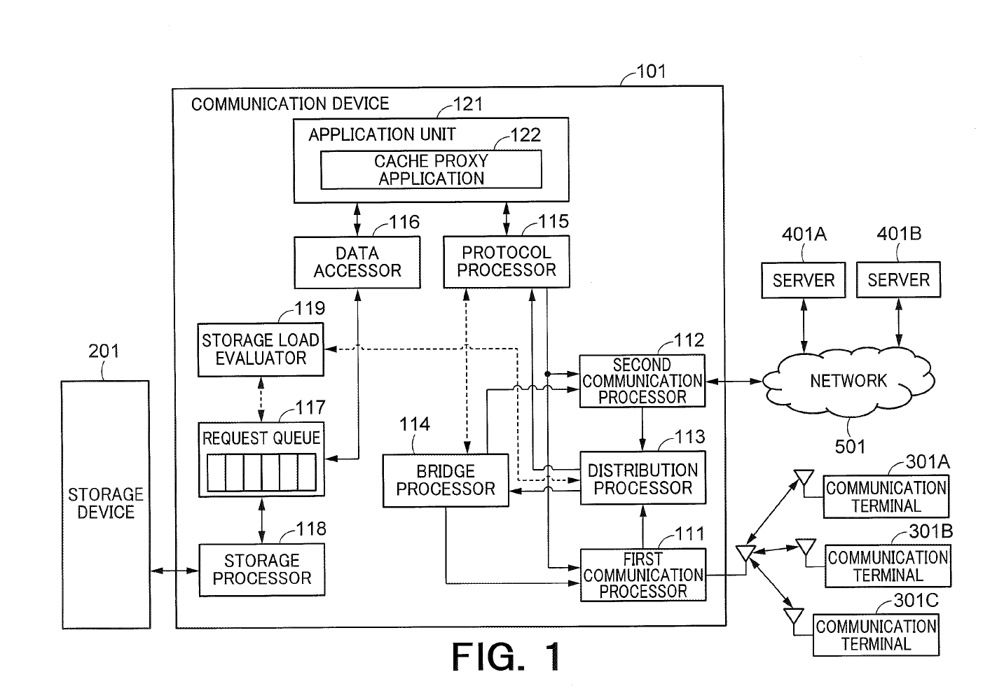

FIG. 1 is a block diagram of a communication device 101 according to a first embodiment of the present invention. The communication device 101 according to this first embodiment includes a first communication processor 111, a second communication processor 112, a distribution processor 113, a bridge processor 114, a protocol processor 115, a data accessor 116, a request queue 117, a storage processor 118, a storage load evaluator 119 and an application unit 121. The application unit 121 includes a cache proxy processor (cache proxy application) 122. The communication device 101 is, by way of example, a relay device such as an access point. These elements may be configured by a circuitry system. As one example, a distribution processor 113, a bridge processor 114, the storage load evaluator 119 and the cache proxy processor 122 may be configured by a circuitry system. The circuitry system can be formed of one circuit or two more circuits. The circuit may be a hardware processor, CPU or dedicated circuit etc.

The communication device 101 is connected to a storage device 201 by an arbitrary interface. In FIG. 1, the storage device 201 is externally connected to the communication device 101, but it may be arranged inside the communication device 101. As specific examples of the storage device 201, there are an SSD (Solid State Drive), an HDD (Hard Disk Drive), an SD card, an eMMC or the like, but it is not limited to them.

The first communication processor 111 communicates with communication terminals 301A, 301B and 301C which are communication devices on a wireless network. The first communication processor 111 performs transmission and reception processing of a packet. The first communication processor 111 has an antenna and communication circuitry. As specific processing, it performs controlling a communication interface, processing on a MAC layer or the like. A wireless LAN network is merely one example, and a cable network may be employed. The communication terminals 301A, 301B and 301C are communication devices, for example, such as a personal computer (PC), a smart phone, a mobile phone, a tablet and the like, which are operated by a user, but the present embodiment is not limited to them as long as having a communication function. For example, they may be household electrical appliances with communication functions. The communication terminals 301A to 301C transmit a data transfer request which requests transmission of data, for example.

The second communication processor 112 is connected to a wired network 501 and communicates with servers 401A and 401B which are communication devices on the network 501. The second communication processor 112 performs transmission and reception processing of a packet. As specific processing, it performs controlling a communication interface, processing on a MAC layer or the like. A wired network is merely an example, and a wireless network may be employed instead. The second communication processor 112 includes communication circuitry and may have an antenna. The servers 401A and 401B are the communication devices which receive the data transfer request which requests transmission of data and return a response including the requested data. They are for example, an HTTP server (an Web server), an FTP server or the like. However, the present embodiment is not limited to them as long as having a function of returning the requested data. They may be communication devices such as a PC, a smart phone or the like, which are operated by a user, as long as having such a function.

The protocol processor 115 performs various kinds of protocol processing and performs data transmission and reception between the application unit 121 and the server as well as the application unit 121 and the communication terminal. In transmitting the data, the protocol processor 115 receives the data from the application unit 121, performs packet processing and transmits the packet to the first communication processor 111 or the second communication processor 112. In data reception processing, it performs protocol processing on the packet received from the first communication processor 111 or the second communication processor 112 to acquire the data included in the packet and passes the data to the application unit 121. As specific example of the protocol processing, there is a TCP/IP, a UDP/IP, an/a SSL/TSL, an IPSec or the like, but it is not limited to them. The TCP/IP is assumed in the description of the present embodiment.

The data accessor 116 receives a request from the upper application unit 121 and performs necessary processing for reading or writing data such as calculation of an address of data stored, generation of a request command (request) and the like. The data accessor 116 passes the request command for accessing to the data in the storage device 201 to the request queue 117. As specific processing, processing of a file system and processing of a part of a block layer and the like are performed.

The request queue 117 holds the request inputted from the data accessor 116 inside. A structure of the request queue 117 is, by way of example, a FIFO. The request queue 117 sequentially passes requests which are held inside to the storage processor 118. As a specific configuration of the request queue 117, there is a queue existing inside the file system, a queue existing inside the block layer, a queue existing inside a driver of a storage controller or the like. Each queue holds requests from an upper layer and sequentially passes them to a lower layer at timings when they become issuable. The file system is the upper layer of the block layer, and the block layer is the upper layer of the storage controller.

As the queue which is present in the file system, there is the queue managing requests which are passed from an upper application by using an API such as “read ( )” or “write ( )”. As the queue which is present in the block layer, there is the queue which manages the requests each specifying an address (or a block) of the storage device 201 which is accessed, and this address is indicated by using a descriptor or the like. As the queue which is present in the driver of the storage controller, there is the queue managing the request such as a register access or a DMA transfer command or the like, which are issued to the storage driver. For example, the file system receives the request for reading or writing the file (the data) requested from the cache proxy application and stores this in the request queue. The file system specifies the block (the address) where the requested file (data) is stored from the request retrieved from the request queue and outputs the request of reading or writing the block (the address) to the block layer. The block layer stores the request of this block in the request queue. The block layer generates the request such as the register access, the DMA transfer command or the like, from the request retrieved from the request queue and outputs it to the storage driver (such as a NAND driver or the like). The storage driver stores this request in the request queue. The storage controller converts the request retrieved from the request queue to a command with which the storage device is compatible, and outputs the command to the storage controller.

The storage processor 118 performs writing or reading data at an address of the storage device 201 on the basis of the request which is passed from the request queue. As specific processing of the storage processor 118, there are a part of processing of the block layer, control processing of the storage controller or both.

The storage device 201 stores cache data for the cache proxy application and the like. The cache data may be stored in association with a URI such as a URL or a data identifier, for example. A log area, a software stack, the data other than the cache proxy application, or all of them may be arranged in the storage device 201.

The storage load evaluator 119 performs an evaluation of a load state (load evaluation) of the storage device 201. In an evaluation method of the load state of the storage device, an access throughput to the storage processor 118 from the storage device 201, the number of requests issued to the storage device 201 or the like, is used. The storage load evaluator 119 is one example of a state acquiring circuit which acquires information indicating the state of the storage device 201. The storage load evaluator 119 evaluates the load state of the storage device 201 on the basis of the acquired information.

As for a method for acquiring the throughput information, a method such as S.M.A.R.T (Self-Monitoring, Analysis and Reporting Technology), which uses a function provided with an HDD or an SSD, may be applied. Prepared is the function which calculates an amount of the data read from the storage device 201 or an amount of the data written to the storage device 201, and the throughput (for example, an amount of writing or reading data per unit time) may be calculated by using this function.

Additionally, a method for acquiring the number of the issued requests may be realized by using the information of the request queue 117 or using a dedicated structure to hold the number of the request commands (requests) issued to the storage device 201. In the present embodiment, it is assumed that the load evaluation of the request queue 117 is employed.

In the load evaluation by the request queue 117, a threshold value is set beforehand, and if the number of requests held in the request queue 117 is larger than the threshold value, then the load of the storage device 201 is evaluated to be high. If it is equal to or less than the threshold value, the load of the storage device 201 is evaluated to be low. The threshold value may be able to be changed from the application unit 121. Moreover, the number of requests may be counted per request type such as writing, reading or the like, and threshold values may be set individually therefor.

The distribution processor 113 determines that the packet received from the first communication processor 111 or the second communication processor 112 be passed to either the protocol processor 115 or the bridge processor 114. For this determination, header information of the packet and the evaluation result of the storage load evaluator 119 are used.

The bridge processor 114 transmits the packet received from one of the first communication processor 111 and the second communication processor 112 to the other communication processor. Such processing is referred to as “bridge processing”. In the present embodiment, it receives the packet from the distribution processor 113 and determines to transmit to either the first communication processor 111 or the second communication processor 112 from the header information of the packet or the like. At this point, the bridge processor 114 may perform packet filter processing from filter information or the like which is set in advance. Moreover, the bridge processor 114 may perform NAT (Network Address Translation) processing.

A cache proxy processor (also referred to as a cache proxy application) 122 of the application unit 121 performs cache proxy processing on the basis of the packet passed from the protocol processor 115. The cache proxy processor 122 is one of the applications which operates in the application unit 121. The cache proxy application performs reading or writing data to the storage device 201 by issuing an access request for accessing the storage device 201 to the data accessor 116. The data written in the storage device 201 corresponds to the cache data. As for an example of a protocol processed by the cache proxy application, there is an HTTP, an HTTPS, an FTP or the like, but it is not limited to them. In the present embodiment, the cache proxy application processes the HTTP.

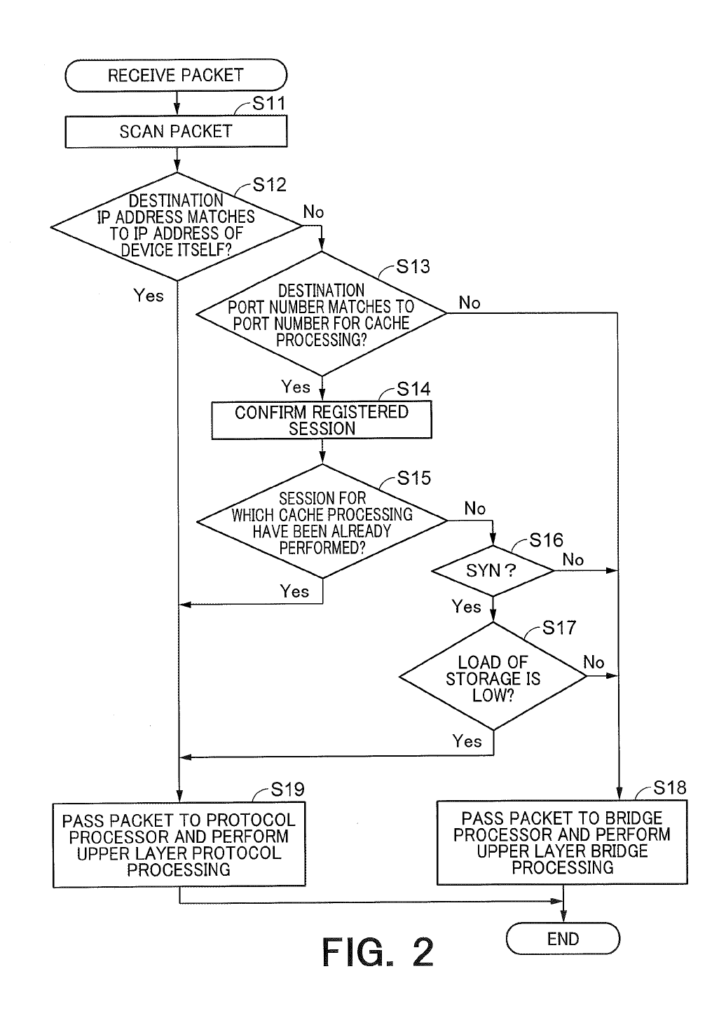

The operation of the communication device 101 according to the first embodiment will be now described using FIG. 1 and FIG. 2. FIG. 2 is a flowchart showing the operation of the communication device 101 according to the first embodiment. In the description below, an example is shown in which the data transfer request from the communication terminal has been issued wherein the data transfer request is a request that the communication terminal requests the server to transmit the data to the self-terminal. However, similar operation can be possible in a case of issuing a data transmission request to the server from the communication terminal wherein the data transmission request is a request that the communication terminal transmits the data to the server from the self-terminal. Also, similar operation can be possible in a case of issuing a data transfer request to the communication terminal from the server wherein the data transfer request is a request that the server requests the communication terminal to transmit the data to the self-server.

When the communication terminal issues the data transfer request to the server so as to transfer the data from the server to the self-terminal, a packet related to the data transfer request is transmitted to the communication device 101. The first communication processor 111 of the communication device 101 receives this packet and passes this packet to the distribution processor 113. The packet is transmitted in a form a frame into which the packet is inserted in accordance with an employed protocol (such as a MAC), this frame is received and processed in the first communication processor 111, resulting in that the packet is extracted.

The distribution processor 113 scans the received packet (S11) and acquires header information of the packet. It evaluates whether a destination IP address of the packet matches to an IP address of the communication device 101 on the basis of the packet information (S12), and when they match, it passes this packet to the protocol processor 115 (S19).

When the destination IP address does not match to the IP address of the communication device 101, the distribution processor 113 further checks whether a destination port number matches to a port number predetermined for the cache proxy processing (S13). When the port number does not match, the packet is passed to the bridge processor 114 because the data of this packet is not data targeted by the cache proxy processing (S13).

Here, supplementary explanation will be made regarding the port number for which the cache proxy processing is performed. This port number, by way of an example, is set at the time of starting-up of the cache proxy application 122. The distribution processor 113 may receive a notification of this port number in advance from the cache proxy application 122 or may acquire the port number by referring to the setting information which the cache proxy application manages. In the present embodiment, the data exchanged in the HTTP is data by targeted by the cache proxy application processing (i.e., target data to be cached in the storage device 201). Therefore, as for the port number, a port number 80, a number 8080 or the like, is set up in advance as one example.

When the destination port number matches to the predetermined port number, the distribution processor 113 checks whether a session of this packet matches to the session that is registered to the communication device 101 (S14). Here, the session is a communication connection that is managed by four pieces of information: the destination IP address; a source IP address; the destination port number; and a source port number. The session is stored in a buffer of the cache proxy application 122. The buffer can be implemented by specific hardware; a storage device such as a memory, a hard disk, an SSD or the like.

The session registered in the communication device 101 is either one of the connection for the communication device 101 or the connection which the cache proxy application 122 established with the communication terminal for the cache proxy processing. This being so, when the session of the packet is matched with the registered session (Yes in S15), the session is a session to be processed by the communication device 101 (regardless of the current load state of the storage device 201) and thus the distribution processor 113 passes this packet to the protocol processor 115 (S19). However, when this packet is apparently to be processed in the cache proxy processor 122 (such when the distribution processor 113 can evaluate that the destination IP address is not the self-device and that the destination port number matches to the predetermined port number), the distribution processor 113 may pass the packet to the cache proxy processor 122 directly not via the protocol processor 115.

On the other hand, when the session of this packet does not match to the registered session (No in S15), the distribution processor 113 checks a SYN flag of a TCP header of this packet (S16). When the SYN flag is not set, this session has been already evaluated as the target of the bridge processing (not the target of the cache proxy processing). That is, upon receiving a SYN packet (i.e., a packet in which SYN flag is set) which requests an establishment of a TCP connection, which triggers a start of this session, the load evaluation of the storage device 201 has been already performed and this session has been already evaluated to be the target of the bridge processing. Therefore, this packet is passed to the bridge processor 114. There may be a case where processing of S16 is not necessary depending on a communication protocol to be used.

By contrast, when the SYN flag of this packet is set, because this packet is the SYN packet to perform the request for the establishment of the TCP connection, the distribution processor 113 determines processing applied for this TCP connection (session) to either the cache proxy processing or the bridge processing in accordance with the load state of the storage device 201 (S17). Specifically, the distribution processor 113 acquires information indicating the load of the storage device from the storage load evaluator 119.

Here, the storage load evaluator 119 may evaluate the load of the storage device 201 upon receiving a request from the distribution processor 113 and return information indicating an evaluated result. Alternatively, it may evaluate load of the storage device at an interval of a constant period and return a latest evaluated result at the time of receiving the request from the distribution processor 113.

The distribution processor 113 passes the packet to the protocol processor 115 when the current load of the storage device is low. When it seems to be apparent that the processing of the packet is performed in the cache proxy processor 122, it can be also possible to directly pass the packet to the cache proxy processor 122 not via the protocol processor 115. On the other hand, when the load of the storage device is high, the distribution processor 113 passes the packet to the bridge processor 114.

In the above description, the distribution processing is explained which is performed by the distribution processor 113 on the packet transmitted from the communication terminal. The packet distributed to the bridge processor 114 or the protocol processor 115 is subjected to the relevant processing at the bridge processor 114 or the protocol processor 115. Hereinafter, details of the processing of the bridge processor 114 or the protocol processor 115 will be described.

First, the case where the packet is distributed to the bridge processor 114 will be described. The bridge processor 114 passes the packet received from the distribution processor 113 to the first communication processor 111 or the second communication processor 112. The evaluation to pass the packet to which of the first communication processor 111 and the second communication processor 112 is performed using a MAC address, the IP address or both of them or the like included in the header information. Or, the bridge processor 114 may receive notification information which designates the communication processor upon receiving the packet from the distribution processor 113 and pass the packet to the communication processor designated by the notification information. In the present example, since the communication between the communication terminal and the server is assumed, the packet received from the communication terminal is passed to the second communication processor 112 for transmission to the server.

Next, the case where the packet is distributed to the protocol processor 115 will be described. The protocol processor 115, after receiving the packet from the distribution processor 113 and performing the protocol processing, passes the data included in the packet to the corresponding application unit 121 on the basis of the header information of the packet, the session information or both of them. When necessary, the session information, the header information or both of them are also passed to this application unit 121. Specifically, the application unit 121 to which the data, the header information and the session information are passed is the cache proxy application (the cache proxy processor) 112 when the destination IP address of the packet does not match to the IP address of the communication device 101 and the port number is the destination port number that performs the cache proxy processing. In other cases, it is an application, for example, such as an HTTP server application, which is another application which operates in the application unit 121.

The cache proxy processor 122 evaluates whether the session of this packet has been registered and if it has not registered yet, the cache proxy processor 122 establishes a connection between the communication terminal and the self-device (the communication device 101) and registers the session information (the communication terminal—the communication device 101). At this time, the IP address and the port number of the communication device 101 in the session information are, by way of an example, made same as those of the server (thus same as the destination IP address and the destination port number of the packet transmitted from the communication terminal).

Moreover, the cache proxy processor 122 establishes a connection between the server having the destination IP address of this packet (thus the server which the communication terminal has designated as the destination) and the communication device 101, and registers session information (the communication device 101—the server). Thus, by transmitting a connection establishment request to the server having the destination IP address of the packet, the communication device 101 establishes the connection with the server. The connection between the server and the communication device 101 and the connection between the communication terminal and the communication device 101 are managed to be associated with each other.

The cache proxy processor 122 performs data processing of the received packet when it establishes the above two connection and registers respective session information or when the packet session has been already registered. When the packet data is a data transfer request such as an HTTP GET request, the cache proxy processor 122 checks whether the data requested by this data transfer request (for example, the data existing in the URL requested by the HTTP GET request) is cached in the storage device 201. When the received packet is the packet which requests the connection establishment such as the SYN packet, there may be a case where the data transfer request is not included in this packet. In this case, a procedure depending on a communication protocol to be used may be implemented such as returning the packet having a SYN flag and an ACK flag set therein to the communication terminal.

Hereinafter, a state that this data is cached in the storage device 201 may be expressed as a state that the cache data is present in the storage device 201. Processing of the case where the cache data is present in the storage device 201 and the case where it is not present will be respectively described.

When the cache data is not present in the storage device 201, the cache proxy processor 122 issues a data transfer request to the server. Thus, the cache proxy processor 122, as a proxy of the communication terminal, issues the data transfer request to the server. Specifically, the cache proxy processor 122 generates an HTTP request and passes it to the protocol processor 115. The protocol processor 115 performs protocol processing such as an addition of a TCP/IP header and passes the packet to the second communication processor 112. The second communication processor 112 transmits the received packet to the server.

The second communication processor 112 receives the packet which is a response to the data transfer request from the server. In more detail, the second communication processor 112 receives a frame in accordance with a communication protocol to be used, performs reception processing of the frame and extracts the packet. The second communication processor 112 passes this packet to the distribution processor 113. The distribution processor 113 grasps that the packet is addressed to the communication device 101 from an IP header of the packet and passes the packet to the protocol processor 115. The protocol processor 115 performs protocol processing of this packet, grasps that the packet is addressed to the cache proxy processor 122 from the IP header or the like and passes this packet to the cache proxy processor 122. The cache proxy processor 122, using the session information with the communication terminal (i.e. session information between the communication terminal and the communication device 101), performs transmission processing of this data through the protocol processor 115 and the first communication processor 111 to transmit the received packet data to the communication terminal. At this time, the cache proxy processor 122 stores the received data from the server as the cache data in the storage device 201. As an example, a transmission source IP address of a packet transmitted to the communication terminal is the same IP address as that of the server and a transmission source port number is also the same port number (destination port number of the packet which the communication terminal transmits) as that of the server. Therefore, the communication terminal seems that the self-terminal communicates with the server.

Processing of the case where the cache data is present in the storage device 201 will be now described. When the cache data is present, the cache proxy processor 122 reads the data requested from the communication terminal from the storage device 201 and transmits a response including this data to the communication terminal. Specifically, the cache proxy processor 122 adds an HTTP header etc. to the data which is read from the storage device 201 and passes it to the protocol processor 115. The protocol processor 115 performs protocol processing such as the addition of the TCP/IP header and passes the packet to the first communication processor 111, and the first communication processor 111 transmits the packet to the communication terminal. At this time, by way of an example, the transmission source IP address of a packet is set to the same IP address as the server and the transmission source port number is also set to the same port number as that of the server (the destination port number of the packet which the communication terminal transmits). Therefore, the communication terminal seems that the self-terminal communicate with the server.

By the above processing, when receiving, from the communication terminal, the packet which requests a connection establishment with the server, the cache proxy processor 122 once terminates the connection and establishes a new connection with the server. This enables that the communication device 101 accesses the server as the proxy of the communication terminal.

The operations of the cache proxy processor 122 are not limited to the operations of the present embodiment as stated above. As long as a general cache proxy is used that acquires data from the server instead of the communication terminal, caches the data to the storage device 201 and responds from the cache data of the storage device 201 to a data transfer request directed to the same data, another operation different the above stated operations is allowed. For example, as a different operation example from the present embodiment, a configuration may be used which establishes continuously connections between the communication terminal and the communication device 101 and between the communication device 101 and the server, respectively (regardless of whether the bridge processing is performed or not). The communication terminal may encapsulate packet which includes the request directed to the server on the basis of the IP address and the port number of the communication device 101 and the port number and transmit the encapsulated packet. In this case, the communication device 101 always communicates with the server by using the IP address and the port number of the self-device as the transmission source IP address and the transmission source port number even in either of when the communication device 101 performs the bridge processing or when it performs the cache proxy processing. In this operation example, though load of the protocol processor 115 increases, the effect can be still achieved that prevents the performance of the overall system from reducing due to the storage device 201 being a bottleneck.

In the present embodiment, the load state of the storage device is evaluated on the basis of the number of the requests, throughput to the storage device and the like, but an embodiment of the present invention are not limited to this. For example, information such as a frequency at which the data transfer request being the target of the cache proxy application processing is received from the communication terminal and a data size which is requested by the data transfer request may be acquired by the state acquiring circuit according to the present embodiment, and the load state of the storage device may be indirectly evaluated on the basis of the frequency, the data size and the like. For example, when the number of data transfer requests received per fixed time (or an average of the numbers of data transfer request) is equal to or more than the threshold value, the load of the storage device may be evaluated to be high; and when it is less than the threshold value, the load of the storage device may be evaluated to be low. Alternatively, a sum of the file sizes requested during an immediately previous fixed time (or an average of the sums) is calculated, and when this sum is equal to or more than the threshold, the load of the storage device may be evaluated to be high; and when it is less than the threshold value, the load of the storage device may be evaluated to be low.

As another example, it is assumed a case where the application unit of the communication device receives a generation instruction (or a writing instruction) of a file to the storage device, a reading instruction or the like, from a user input interface (a touch panel, a key board, a mouse and the like) or another application and performs to generate or to read the file to the storage device. In this case, a frequency of instructions from a user, the file size or the like, may be acquired by an information acquiring circuit according to the present embodiment, and the load state of the storage device may be indirectly evaluated on the basis of this frequency, this file size or the like. For example, when the number of the instructions received during an immediately previous fixed time (or an average of the numbers of instructions) is equal to or more than the threshold value, the load of the storage device may be evaluated to be high; and when it is less than the threshold value, the load of the storage device may be evaluated to be low. Alternatively, the sum of the file sizes of the instructions received during an immediately previous fixed time (or an average of the sums) is calculated, and when the sum size is equal to or more than the threshold value, the load of the storage device may be evaluated to be high; and when it is less than the threshold value, the load of the storage device may be evaluated to be low.

Additionally, as another example, it is assumed a case where the packet transmitted to the server from the second communication processor 112 is acquired at the information acquiring circuit according to the present embodiment by using a switch mirroring or other equivalent means. If this packet is the data transfer request transmitted toward the server from the communication device, it is considered to be the data transfer request transmitted by the cache proxy application 122. Therefore, the load of the storage device may be evaluated by using a frequency of the data transfer requests, the data sizes requested by the data transfer requests and the like. For example, when the number of the data transfer requests transmitted during an immediately previous fixed time (or an average of the numbers of the data transfer requests) is equal to or more than the threshold value, the load of the storage device may be evaluated to be high; and when it is less than the threshold value, the load of the storage device may be evaluated to be low. Alternatively, the sum of the file sizes requesting during an immediately previous fixed time (or an averages of the sums) is calculated, and when the sum is equal to or more than the threshold value, the load of the storage device may be evaluated to be high; and when it is less than the threshold value, the load of the storage device may be evaluated to be low.

By a method other than that mentioned above, it is also possible to evaluate the load state of the storage device.

In this way, according to the first embodiment, when the load of the storage device 201 is high, the cache proxy processing is skipped and the bridge processing is performed. Thereby, it is able to avoid the performance degradation of the overall system caused due to the storage device 201 being a bottleneck. Thus, even when a load of the storage device is temporarily high, the operation as the communication device (the relay device or the like) can be continued at a minimum.

Moreover, according to the present embodiment, by evaluating the load of the storage device 201 before passing the packet to the protocol processor 115, the effect of reducing these unnecessary overhead is also achieved. For example, a method is considered to pass the packet absolutely to the protocol processor 115 without arranging the distribution processor 113, to measure the load of the storage device 201 at the application unit 121 such as the cache proxy processor 122, and when the load is high, to pass the packet to the bridge processor 114. However, in this case, unnecessary protocol processing or application processing may occur at every packet. On the contrary, the present embodiment can reduce these unnecessary processing by evaluating the load of the storage device 201 before passing the packet to the protocol processor 115.

As mentioned above, the communication device according to the present embodiment switches operations between the bridge processing and the cache proxy processing in accordance with the load state of the storage device 201. Monitoring the packet received at the first communication processor 111 and the packet transmitted from the second communication processor 112 from outside enables to detect which operation is performed (without checking the operation inside the communication device).

When the packet of the data transfer request to the server is received at the first communication processor 111 in the state in which a certain load (first access load) is applied to the storage device 201, whether this packet has been transferred from the second communication processor 112 is monitored. When the packet transfer is detected, it can be evaluated that the high load is applied to the storage device 201 and that the bridge processing is performed at the communication device. On the other hand, in the case where the packet of the data transfer request to the server is received at the first communication processor 111 in the state in which the lower load (second access lord) than the first access load is applied to the storage device 201, when this packet is not transferred to the server from the second communication processor 112, it can be evaluated that the cache proxy processing is performed at the communication device. Here, the case where this packet is not transferred to the server from the second communication processor 112 includes the case where any packet is not transmitted and the case where the packet is transmitted at the session which is set between the communication device and the server.

By using a means for mirroring the packet received at the first communication processor 111 by a switch or the like and acquiring the mirrored packet, a means for mirroring the packet transmitted from the second communication processor 112 by a switch or the like and acquiring the mirrored packet or means for both of the above, whether packet transfer is performed or not may be evaluated. A monitoring device having such an evaluating means may be provided. The monitoring device may be physically one device or may be configured from a plurality of devices interconnected through a network.

As a method to apply the load to the storage device 201, an amount to apply the load to the storage device 201 may be adjusted with writing instructions to the files to the storage device 201, reading instructions of files or the like. For example, a state in which writing instructions or reading instructions of a large amount of files are given and executed may be defined as a state in which the first access load is applied. Moreover, a state in which any writing instructions or any reading instructions are not given or a state in which writing instructions or reading instructions of a small amount of files are given and executed may be defined as a state in which the second access load is applied. The load to be applied to the storage device 201 may be adjusted by a method other than that mentioned here. For example, the load to be applied to the storage device 201 may be adjusted by the number of writing instructions or reading instructions. The above monitoring device may have means for applying the load to the storage device 201.

### Second Embodiment

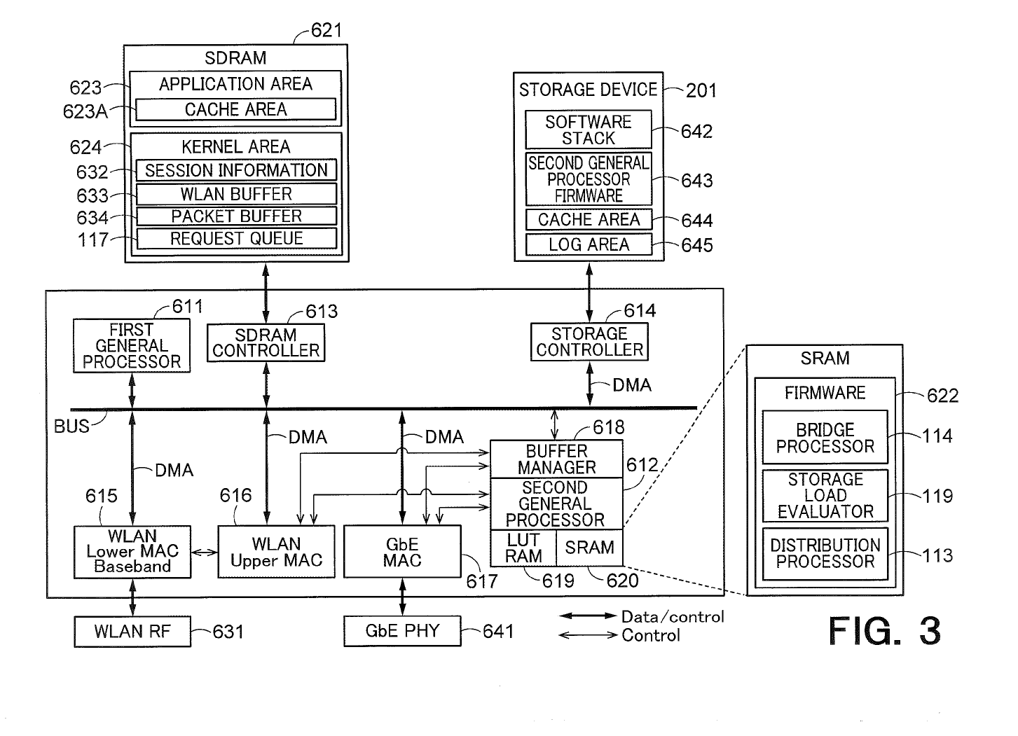

In a second embodiment, examples of a specific hardware configuration and software configuration of the communication device according to the first embodiment will be described. FIG. 3 is a diagram showing an example of a communication device related to the second embodiment.

The communication device of FIG. 3 includes a first general processor 611, a second general processor 612, an SDRAM 621, an SDRAM controller 613, a storage device 201, a storage controller 614, a WLAN RF 631, a WLAN Lower MAC Baseband 615, a WLAN upper MAC 616, a GbE (1 Gigabit Ethernet (R)) PHY 641, a GbE MAC (1 Gigabit Ethernet MAC) 617, a buffer manager 618, a LUT (Look-up Table) RAM 619 and an SRAM 620. Each of the first general processor 611 and the second general processor 612, as an example, is configured by a processor such as a CPU. The buffer manager 618, the second general processor 612, the RAM 619 and the SRAM 620, which are collectively placed in the figure, may be configured by one integrated circuit (chip) or may be configured by a plurality of chips, by way of an example.

The WLAN RF 631 performs transmission and reception of wireless signal with external wireless terminals by radio. Upon reception processing, the WLAN RF 631 performs signal processing of the radio signal (or wireless signal) and acquires a frame, and passes to the WLAN Lower MAC Baseband 615. Upon transmission processing, the WLAN RF 631 performs the signal processing on the frame received from the WLAN Lower MAC Baseband 615 and transmits the radio signal.

The WLAN Lower MAC Baseband 615 performs processing of a lower layer of a WLAN MAC. Upon reception processing, it receives the frame from the WLAN RF 631, performs the processing of the lower layer of the WLAN MAC and passes the resultant to the WLAN Upper MAC 616 described later. Upon transmission processing, it performs the processing of the lower layer of the WLAN MAC on the frame received from the WLAN Upper MAC 616 and then passes the resultant to the WLAN RF 631. In the present embodiment, transfer of the frame with the WLAN Upper MAC 616 is assumed to be performed through a WLAN buffer 633 which is allocated in the SDRAM 621 described later, but the present invention is not limited to this configuration. For example, it may be such a configuration which a buffer is installed inside any element(s) (or any block(s)) and a frame may be passed directly.

The WLAN Upper MAC 616 performs processing of an upper layer of the WLAN MAC. Upon reception processing, it receives the frame from the WLAN Lower MAC Baseband 615, performs the processing of the upper layer of the WLAN MAC and passes the processed frame (which may be a form of a packet here) to the second general processor 612. Upon transmission processing, it receives the frame from the second general processor 612, performs the processing of the upper layer of the WLAN MAC and passes the processed frame to the WLAN Lower MAC Baseband 615. In the present embodiment, transfer of the frame with the WLAN Lower MAC Baseband 615 is assumed to be performed through the WLAN buffer 633 allocated in the SDRAM 621 and the transfer of the frame with the second general processor 612 is assumed to be performed through a packet buffer allocated in the SDRAM, but they are not limited to this configuration. For example, it may be such a configuration which the buffer is installed inside any element(s) (any block(s)) and the frame may be passed directly. As for the transfer of the frame via the packet buffer, in explanation of the buffer manager 618 as described below, detail thereof will be described.

The GbE MAC 617 is a 1 Gigabit Ethernet MAC and performs a MAC processing. Upon reception, the GbE MAC 617 performs the MAC processing on a frame received from the GbE PHY 641 and passes it to the second general processor 612. Upon transmission, the GbE MAC 617 receives the frame from the second general processor 612, performs the MAC processing on the frame and transmits the resultant from the GbE PHY 641. In the present embodiment, the transfer of the frame with the second general processor 612 is assumed to be performed through the packet buffer 634 allocated in the SDRAM 621, but the present invention is not limited to this.

The buffer manager 618 manages the packet buffer allocated in the SDRAM 621. As an example of a packet buffer management, the buffer manager 618 manages each of the packet buffers by a buffer identifier and a descriptor which corresponds to the identifier. In the descriptor, an attributes such as an address of the packet buffer, an owner of a memory (an application or the like), and details of processing to be next executed or the like are described. By notifying the buffer identifiers to each other, the relevant element(s) can refer to the descriptor of the particular packet buffer and execute the transfer the packet or the frame.

The second general processor 612 executes a firmware 622 which is stored in the SRAM 620. A method can be considered that the firmware 622 is stored in a storage device 201 and the firmware 622 is read out to the SRAM 620 upon activation of a communication device or upon initializing the second general processor. The second general processor 612 offloads a part of communication processing from the first general processor 611. Processing executed at the second general processor 612 is the communication processing where the processing is simple and frequently executed. Thus, such effects are expected that high-speed communication processing can be executed while processing of load of the first general processor 611 is suppressed. In the present embodiment, the firmware 622 has functions of a bridge processor 114, a storage load evaluator 119 and a distribution processor 113, and the second general processor 612 executes these processing. Moreover, the second general processor 612 retains information required for processing such as session information, information required to classify packets and the like in the LUP RAM 619, the SRAM 620 or both of them and executes the processing by using them. However, a configuration in which information are read from the SDRAM 620 may be used without providing the LUT RAM 619.

The SDRAM controller 613 is connected to the SDRAM 621, receives an access from the relevant element(s) and performs reading and writing of data for the SDRAM 621. An access by a DMA transfer with using a DMAC (Direct Memory Access Controller) (not shown in the figure) is assumed for the access from the relevant element(s), but the present invention is not limited to this configuration.

A necessary memory area for each processing is allocated in the SDRAM 621. In the present embodiment, an application area 623 and a kernel area 624 are allocated. A cache area 623A which is used in cache proxy processing is set in the application area 623. A session information 632 required in TCP/IP processing (such as an IP address and a port number, a sequence number or the like), a WLAN buffer 633 which temporarily retains the frame, a packet buffer 634 which temporarily retains the packet and a request queue 117 are allocated in the kernel area 624. A request between layers such as a file system, a block layer, storage driver processing and the like are retained in the request queue 117 in order to access the storage device 201.

The storage controller 614 is connected to the storage device 201, receives an access from the relevant element(s) and performs reading and writing of data for the storage device 201. The access by the DMA transfer with using the DMAC (not shown in the figure) is assumed for the access from the relevant element(s), but the present invention is not limited to this configuration.

A software stack 642 of the first general processor 611, a firmware 643 for the second general processor 612, a cache area 644 which is used as a cache area of the cache proxy processing, a log area 645 to store a log such as an operation or an error of the communication device or the like and the like are allocated in the storage device 201.

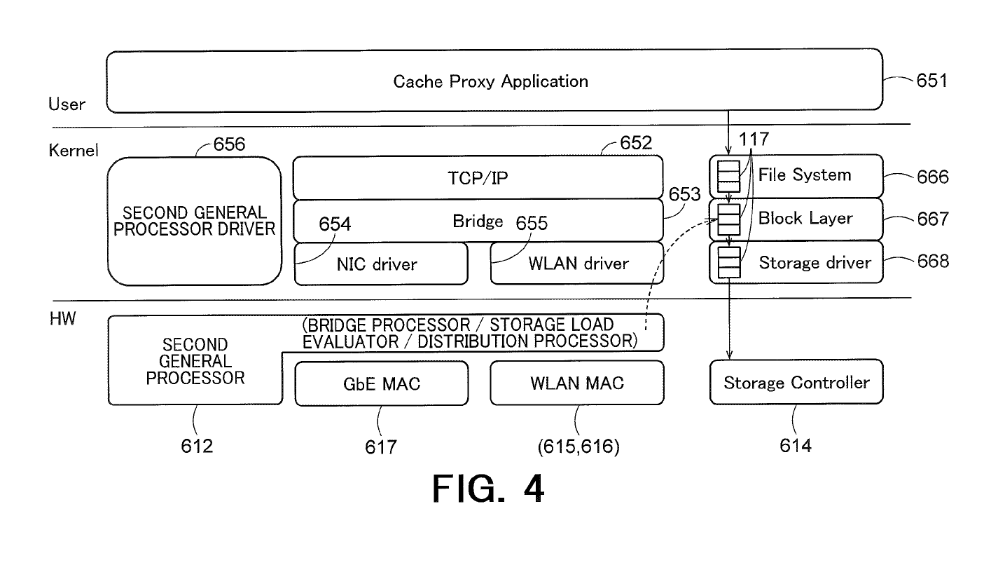

The first general processor 611 executes controlling of the relevant element(s), communication processing, processing for the storage device, file system processing, the cache proxy processing or the like by using the software stack 642 which is stored in the storage device 201. A system configuration including the software stack 642 of the first general processor 611 is shown in FIG. 4.

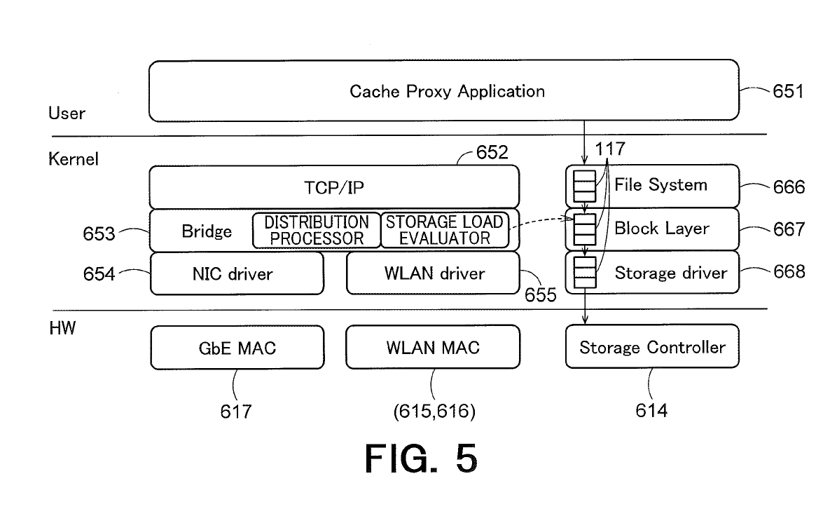

A cache proxy application 651 of the software stack 642 performs the cache proxy processing. A TCP/IP 652 in a kernel space performs protocol processing such as an addition of a TCP/IP header to data to be transmitted, an analysis of the TCP/IP header of the packet or the like. A bridge 653 performs bridge processing between communication interfaces (communication processor). The second general processor 612 may perform the bridge processing of the packet between the GbE MAC 617 and the WLAN MAC (615, 616). The second general processor 612 may also perform a storage load evaluation and distribution processing of a received packet. As shown in FIG. 5, in the case where the second general processor is not present, the first general processor 611 may perform the bridge processing, the storage load evaluation and the distribution processing of the received packet. Moreover, even in the case of complicated processing such as the bridge processing which includes filtering processing based on a complicated rule or the like, the processing may be performed in the bridge 653 of the first general processor but not in the second general processor. A NIC Driver 654 is a device driver which performs control of the GbE MAC 617. A WLAN driver 655 is a device driver which performs control of the WLAN MAC (615,616). A file system 666 performs file system processing to access the data which are stored in the storage device 201 in a unit of a file. A block layer 667 performs processing of the block layer to access the data of storage device 201 in a unit of a block. A storage driver 668 is a device driver which performs control of the storage controller 614. A second general processor driver 656 is a driver to control the second general processor 612. In the above, the detail of processing which is performed at the first general processor is described, but the first general processor can also perform other various kinds of processing.

The operations of the communication device according to the second embodiment will be now described with FIGS. 3 and 4. In the explanation of the operations below, an example where a communication terminal connected by a wireless LAN (WLAN) issues a data transfer request to a server connected through the GbE (1 Gigabit Ethernet) will be described, but basic operations will be the same in a case of data transmission to the server from the communication terminal or even in a case where a data transfer request to the communication terminal from the server is performed.

In order for the communication terminal to request to transfer the data to the server, the data transfer request such as an HTTP GET request is transmitted. A wireless signal of the data transfer request is received at the WLAN RF 631 and after it is subjected to reception processing, the resultant frame is passed to the WLAN Lower MAC Baseband 615. The WLAN Lower MAC Baseband 615 writes the frame to the WLAN buffer 633 allocated in the SDRAM 621 and performs the processing of the lower layer of the WLAN MAC. Then, it notifies a written address of the WLAN buffer or the like with information required for subsequent processing to the WLAN Upper MAC 616.

The WLAN Upper MAC 616 performs the processing of the upper layer of the WLAN MAC on the frame stored at the address notified from the WLAN Lower MAC Baseband 615 and also inquires an available packet buffer to the buffer manager 618 and receives the buffer identifier. The WLAN Upper MAC 616 and the WLAN Driver 655 refer to the descriptor by using the buffer identifier received from the buffer manager 618 and acquire an address of the packet buffer. The WLAN Upper MAC 616 and the WLAN Driver 655 write a packet to the packet buffer at the acquired address and sends notification to the effect that the packet has been received, together with the buffer identifier to the second general processor 612.

The second general processor 612 refers to the descriptor by using the received buffer identifier, acquires the address of the packet buffer and performs processing of the packet which is stored in the address. Specific processing of the second general processor 612 are the distribution processing of the received packet, the processing of load evaluation of the storage device and the bridge processing. The distribution processor 113 of the second general processor 612 passes the packet to the bridge processor 114 of the second general processor 612 upon performing processing of Step S18 in FIG. 2 and passes the packet to the first general processor 611 upon performing processing of Step S19. At this time, transfer of the packet is performed by notifying a buffer descriptor.

Here, the storage load evaluator 119 which is executed at the second general processor 612 needs to refer to information of the request queue 117 managed by the first general processor 611. As shown in FIG. 4, the request queue 117 is specifically present each inside of the file system 666, the block layer 667 and the storage driver 668. The request queue 117 is the queue for receiving an access request to the storage device 201 from an upper layer processor and issuing a request to a lower layer processor. The storage load evaluator 119 can access to the information of the request queue 117 which one layer or a plurality of layers among these of the file system, the block layer and the storage driver manages/manage. This being so, the first general processor 611 needs to notify an address of the SDRAM 621 in which the information of the request queue 117 is stored to the storage load evaluator 119 upon initializing the second general processor 612, upon initializing the file system 666, upon initializing the block layer 667, upon the initializing the storage driver 668 or the like.

In examples of FIG. 4 and FIG. 5, the storage load evaluator 119 refers to a request queue of the block layer. It may refer to a request queue of the file system 666 or a request queue of the storage driver 668. Alternatively, it may refer to either two or three of the request queues of the file system 666, the block layer 667 and the storage driver 668.

When the distribution processor 113 delivers the packet to the bridge processor 114, the bridge processor 114 passes the packet to the GbE MAC 617 and the NIC driver 654 by notifying a packet identifier. The GbE MAC 617 and the NIC driver 654 refer to the descriptor by using the received buffer identifier and transmit the packet stored in the packet buffer from the GbE PHY 641.

When the distribution processor 113 transfers the packet to the first general processor 611, the first general processor 611 performs TCP/IP processing on the packet and passes the packet data to an appropriate upper application. The subsequent cache proxy processing or the like are performed in the similar way to the first embodiment. An access to cache data can be carried out as access to the storage device 201 through the storage controller 614 by the file system 666, the block layer 667 and the storage driver 668.

In this way, by employing a hardware configuration and a software configuration according to the second embodiment, the communication device according to the first embodiment can be implemented. Therefore, the communication device according to the second embodiment can provide a similar effect to the first embodiment.

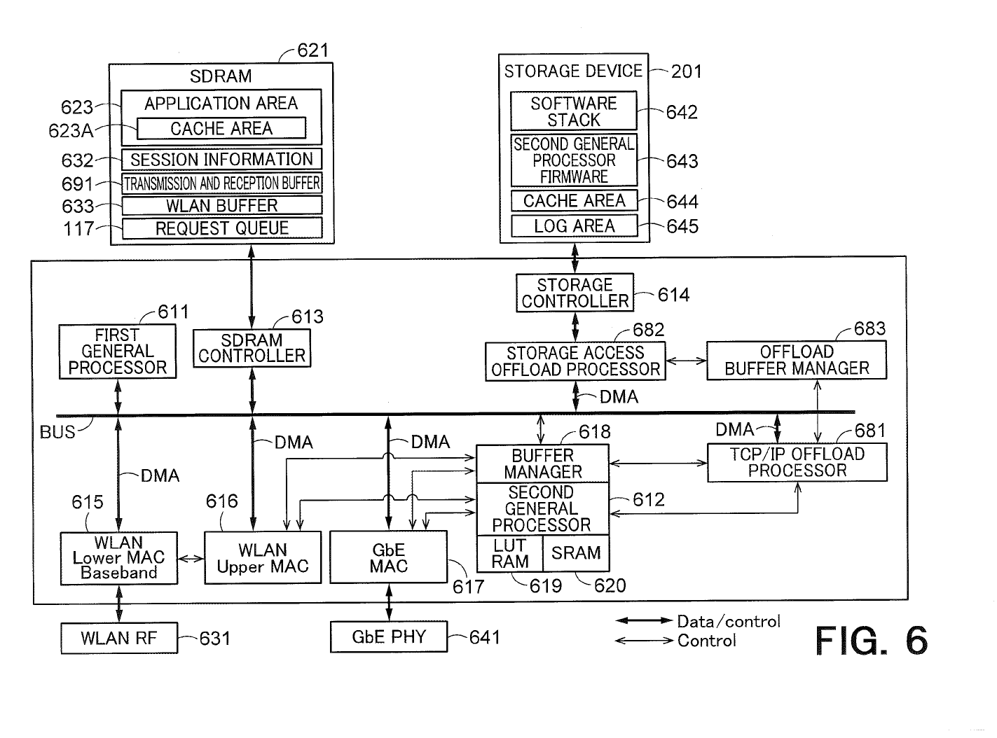

FIG. 6 shows another example of a hardware configuration of the communication device according to the second embodiment. Same signs are provided to the same elements as those in FIG. 3 and an overlapping explanation will be omitted except for processing which has been modified or extended.

The TCP/IP processing is performed at a TCP/IP offload processor 681 which is dedicated hardware and a storage access offload processor 682 which is dedicated hardware is used to access the storage device 201. In this case, transfer of the data between the storage access offload processor 682 and the TCP/IP offload processor 681 is performed through an offload buffer manager 683.

The offload buffer manager 683 manages a transmission and reception buffer 691 referred to by the storage access offload processor 682 and the TCP/IP offload processor 681. As for an example of a method to manage the transmission and reception buffer 691 of the offload buffer manager 683, it manages a head address and an end address in which the data is written for each session. For example, when the cache proxy application transmits the cache data of the storage device 201, the first general processor 611 instructs to read data which are stored in an address of the storage device 201 to the storage access offload processor 682. Moreover, it simultaneously instructs to transmit the data read by the storage access offload processor 682 to the TCP/IP offload processor 681 with a specific session.

The storage access offload processor 682 sequentially reads the data from the storage device 201 and writes the data into a buffer from the head address which the offload buffer manager 683 manages. At this time, the storage access offload processor 682 sequentially updates the end address of buffer information, which indicates a buffer position where writing is completed. The TCP/IP offload processor 681 sequentially reads the data from the head address to the end address of the buffer information managed by the offload buffer manager 683, performs protocol processing and transmits the processed data to a network. At this time, the TCP/IP offload processor 681 sequentially updates the head address of the buffer information, which indicates a buffer position where reading is completed.

In this way, the storage access offload processor 682 and the TCP/IP processor 681 handle one buffer as a ring buffer, thereby it can be possible to perform an efficient transfer.

### Third Embodiment

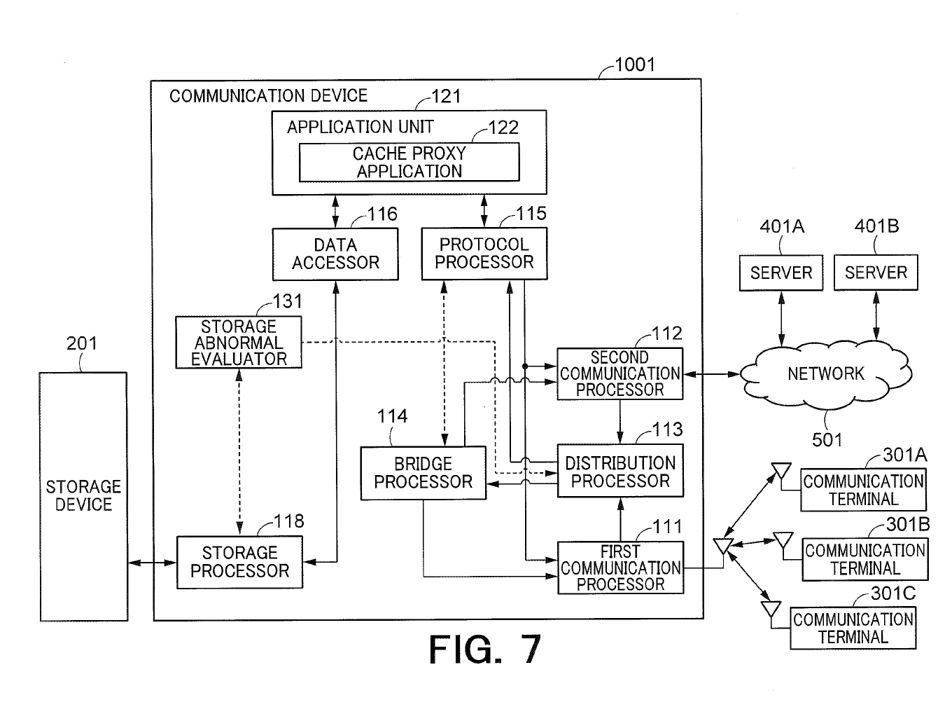

FIG. 7 is a block diagram showing a communication device according to a third embodiment. A communication device 1001 of the third embodiment includes a storage abnormal evaluator 131 instead of the storage load evaluator 119 of the first embodiment. Because other processors are similar to those in the first embodiment, an explanation thereof will be omitted except for processing which has been changed or extended.

The storage abnormal evaluator 131 performs an evaluation whether the storage device 201 operates normally or falls into some abnormal state. The abnormal state of the storage device 201 is, for example, a state in which there is no reply from the storage device 201, a state in which the data cannot be correctly accessed since garbled data or the like occurs. As for a method to evaluate the abnormal state, there are a method to evaluate the abnormal state, for example, by a link error such as an SATA, by detecting an error in at a unit of block of an AHCI or the like. Additionally, a method is also considered which determines occurrence of an abnormal state when an error rate, the number of defective sectors, the number of ECC errors, a temperature or the like, which are included in S.M.A.R.T is larger than a predetermined threshold. The storage abnormal evaluator 131 notifies a current state of the storage device 201 to a distribution processor 113. The storage abnormal evaluator 131 is one embodiment of a state acquiring circuit which acquires information indicating the state of the storage device 201 and, by way of an example, it acquires the information of the link error in the SATA, the error in a unit of block in the AHCI or the like as mentioned above. The storage abnormal evaluator 131 evaluates whether the storage device 201 is in a normal state or in an abnormal state on the basis of this acquired information.

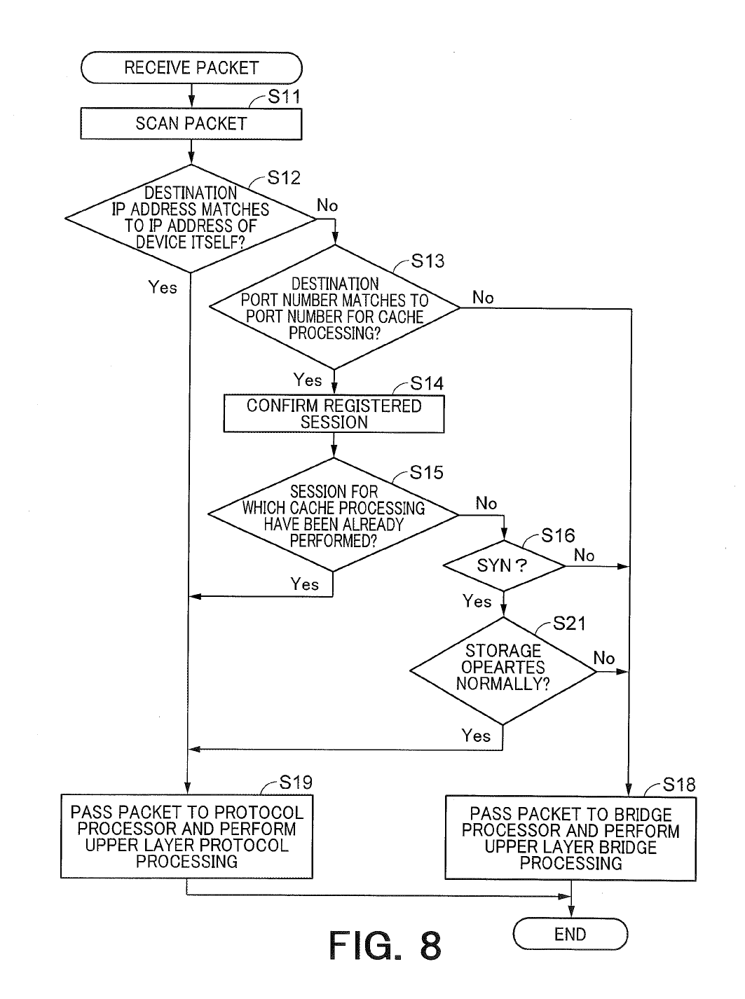

FIG. 8 is a flowchart showing operations of the communication device 1001 according to the third embodiment. A difference from the first embodiment will be described below.

In the third embodiment, when a packet passed to the distribution processor 113 does not belong to a session for which cache proxy processing has been already performed (No in S15) and is a SYN packet, the distribution processor 113 acquires information which indicates a state whether the storage device 201 currently operates in the normal state or in the abnormal state from the storage abnormal evaluator 131. Here, the storage abnormal evaluator 131 may evaluate a presence or an absence of an abnormality of the storage device 201 after receiving a request from the distribution processor 113. Alternatively, the storage abnormal evaluator 131 evaluates the presence or the absence of the abnormality of the storage device 201 at an interval of fixed period and may return a latest evaluated result on receiving the request from the distribution processor 113.

When the current storage device 201 is evaluated to operate in normal from the evaluated result acquired from the storage abnormal evaluator 131, the distribution processor 113 passes the packet to a protocol processor 115. At this time, when it is apparent that the processing of this packet is performed at a cache proxy processor 122 (such when it can be evaluated at the distribution processor 113 that a destination IP address is not a self-device and a destination port number matches to a predetermined port number or the like), it may pass the packet to the cache proxy processor 122 directly not via the protocol processor 115. When the storage device 201 is in abnormal, the distribution processor 113 passes the packet to a bridge processor 114.

On the other hand, the packet passed to the distribution processor 113 belongs to a session for which the cache proxy processing has been already performed (Yes in S15), the distribution processor 113 passes the packet to the protocol processor 115 (S19). In an operational example shown in FIG. 8, when the packet is received and the destination IP address does not match to the IP address of the self-device (No in S12), a state of the current storage device 201 is evaluated. As for another operational example, separately from reception processing of the packet, a configuration may be employed in which, once the abnormal state of the storage device 201 is detected, the distribution processor 113 consistently distributes the packet to the bridge processor 114. The method is efficient in such a case where the storage device 201 breaks down and an access is completely impossible because there is no need to confirm a state of the storage device 201 anymore.

When the abnormal state of the storage device 201 occurs, a manager of the communication device 1001 is assumed to perform a recovery of the storage device 201 by replacing the storage device 201, restoring a file system or the like. When the storage device starts the operation in normal again by the recovery, the cache proxy processing may be performed again. This way is desirable in a view of performance and reduction of an upper network band.

This being so, the storage abnormal evaluator 131 may have a function to detect that the storage device have started the operation in normal and to notify that effect to the distribution processor 113. In the evaluation whether the storage device transitioned from the abnormal state to the normal state, for example, a method is considered that the distribution processor 113 is notified that the storage device is in the normal state in a case that the recovery of the file system is normally completed in conjunction with recovery processing of the file system such as “fschk” or the like. Moreover, a method is considered that, in the case where a replace of the storage device is performed, the distribution processor 113 is notified to be in a normal state in a case that processing is normally completed in conjunction with mount processing of the storage device such as “mount”, to a new file system creation such as “mkfs” or the like. Additionally, a method is also considered which evaluates that the storage device transitioned from the abnormal state to the normal state by monitoring a command which is issued to the storage device or the storage controller, the response thereof or the like. Furthermore, a method is also considered in which, when the recovery of the storage device is completed, a dedicated processor provided in an application unit 121 may notify to the distribution processor 113 from the application unit 121 that the storage device is in the normal state explicitly.

In this way, according to the third embodiment, when the storage device 201 is in the abnormal state, minimum processing of the communication device 1001 other than the cache proxy operation (relay processing or the like) can be possible to be continued by skipping protocol processing and the cache proxy processing and performing the bridge processing. A method is also considered that a packet is necessarily delivered to the protocol processor 115 without providing the distribution processor 113, a presence or an absence of the abnormality of the storage device 201 is observed by the applications such as the cache proxy processor 122 and the packet is passed to the bridge processor 114 at need. However, in this method, useless protocol processing or application processing occurs for each packet in a case that the storage device 201 is in the abnormal state. In the present embodiment, these useless overhead can be reduced by evaluating the presence or absence of the abnormality of the storage device 201 before the packet is passed to the protocol processor 115.

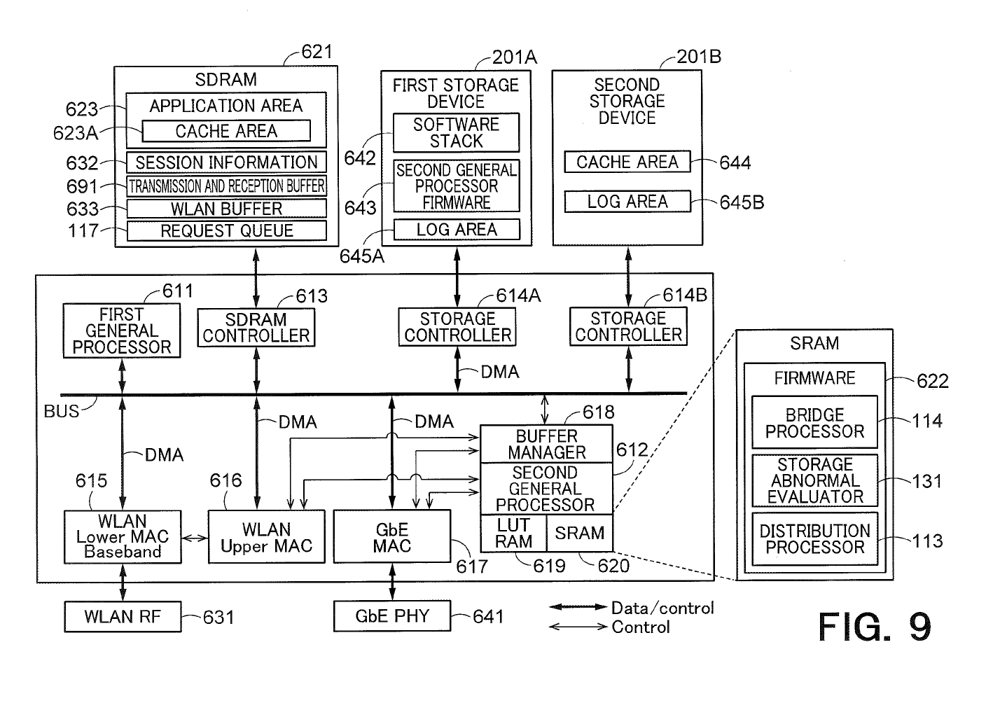

An exemplary hardware configuration of the communication device of FIG. 7 is shown in FIG. 9. Identical signs are provided to the identical or corresponding parts in FIG. 3 according to the second embodiment, and descriptions are omitted except for processing which has been extended or modified.

The communication device in FIG. 9 includes a first general processor 611 and a second general processor 612 and performs a function of the storage abnormal evaluator 131 at the second general processor 612. Moreover, this communication device includes a first storage device 201A and a second storage device 201B. A software stack 642 and a second general processor firmware 643 are stored in the first storage device 201A having a small capacity, and the software stack 642 and the second general processor firmware 643 are required in order to perform a minimum operation of the communication device other than the cache proxy application. Then a cache area 644 is stored in the second storage device 201B having a large capacity. Since reading and writing are performed at high frequency in the cache area 644, a failure probability of the storage device 201B increases. However, by separating information required in order to obtain a minimum operation of the communication device from the second storage device 201B, the minimum operation of the communication device other than the cache proxy processing can be continued even when the second storage device 201B falls into the abnormal state.

Hereby, the communication device of each of the embodiments is able to be implemented, for example, by using a general-purpose computer device as basic hardware. Thus, each of the blocks which the computer device has can be implemented by causing a processor installed on the computer device described above to execute a program. In this case, the communication device may be implemented by installing the program described above to the computer device beforehand or may be implemented by storing to a storage medium such as CD-R, distributing the program described above through a network and installing this program in the computer device as appropriate. Moreover, the storage device can be implemented by using a memory device or a hard disk incorporated in or externally added to the computer device described above or a storage medium such as CD-R, CD-RW, DVD-RAM or DVD-R as appropriate.

Terms which are used in the present embodiment should be interpreted broadly. For example, the term “processor” may include a general-purpose processor, a Central Processing Unit (CPU), a microprocessor, a digital signal processor (DSP), a controller, a microcontroller, a state machine or the like. The “processor” may also indicate such as an application specific integrated circuit, a Field Programmable Gate Array (FPGA), a Programmable Logic Device (PLD) or the like depending on situations. The “processor” may also indicate a combination of processing devices such as a plurality of microprocessors, a combination of a DSP and a microprocessor or one or more microprocessors which operate/operates with a DSP core.

As another example, a term “memory” may include an arbitrary electronic component which can store electronic information. The “memory” may indicate such as a Random Access Memory (RAM), a Read Only Memory (ROM), a Programmable Read Only Memory (PROM), an Erasable Programmable Read Only Memory (EPROM), an Electric Erasable Programmable Read Only Memory (EEPROM), a Non Volatile Random Access Memory (NVRAM), a flash memory, a/an magnetic or optical data storage, and they are readable by the processor. If the processor performs reading or writing information to the memory or performs both of them, it can be said that the memory electrically communicates with the processor. The memory may be integrated to the processor, and also in this case, it can be also said that the memory electrically communicates with the processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A communication device comprising:
a first communication processor configured to communicate with a first communication device;
a second communication processor configured to communicate with a second communication device; and
a bridge processor configured to perform bridge processing which receives a first data transfer request for the second communication device received at the first communication processor to transmit the first data transfer request through the second communication processor, and receives a first response having been received at the second communication processor to transmit the first response through the first communication processor, the first response including data requested by the first data transfer request;
a cache proxy processor configured to perform proxy processing which examines whether the data requested by the first data transfer request is present in a storage device, transmits a second response including the data through the first communication processor when the data is present, transmits a second data transfer request which requests transmission of the data for the second communication device through the second communication processor when the data is not present, stores a data included in a third response for the second data transfer request from the second communication device in the storage device and transmits a fourth response including the data through the first communication processor;
a state acquiring circuit which acquires information indicating a state of the storage device; and
a distribution processor configured to determine, when the first data transfer request is received at the first communication processor, one of the bridge processing and the proxy processing in accordance with the state of the storage device,
wherein the bridge processor performs the bridge processing when the bridge processor is determined and the cache proxy processor performs the proxy processing when the cache proxy processor is determined.

2. The communication device according to claim 1,
wherein the state acquiring circuit evaluates whether a load state of the storage device is high or low on the basis of the information indicating the state of the storage device, and
wherein the distribution processor determines the bridge processing when the load state of the storage device is high and determines the proxy processing when the load state of the storage device is low.

3. The communication device according to claim 2,
wherein the state acquiring circuit acquires information indicating a throughput of the storage device and evaluates the load state of the storage device on the basis of the throughput.

4. The communication device according to claim 2, comprising a request queue to store requests for writing into or reading from the storage device,
wherein the state acquiring circuit evaluates the load state of the storage device in accordance with a number of the requests which are present in the request queue.

5. The communication device according to claim 4, comprising a first general processor and a second general processor,
wherein the first general processor executes processing of the cache proxy processor, control processing of the first communication processor, control processing of the second communication processor and control processing of the storage device,
wherein the second general processor executes processing of the bridge processor, the distribution processor and the state acquiring circuit, and
wherein the state acquiring circuit of the second general processor acquires information of the number of the requests which are present in the request queue.

6. The communication device according to claim 1,
wherein the state acquiring circuit evaluates whether the storage device is in a normal state or in an abnormal state on the basis of the information indicating the state of the storage device, and
wherein the distribution processor determines the bridge processing when the storage device is in the abnormal state and determines the proxy processing when the storage device is in the normal state.

7. The communication device according to claim 5,
wherein the state acquiring circuit evaluates whether the load state of the storage device is high or low, and
wherein the distribution processor determines the bridge processor when the storage device is in the normal state and the load state of the storage device is high and determines the cache proxy processor when the storage device is in the normal state and the load state of the storage device is low.

8. The communication device according to claim 6,
wherein the distribution processor, after the abnormal state is determined, consistently determines the bridge processor without receiving a notification whether the storage device is in the normal state or in the abnormal state from the state acquiring circuit.

9. The communication device according to claim 8,
wherein the state acquiring circuit detects that the storage device becomes the normal state from the abnormal state, and
wherein the distribution processor, in response to the first data transfer request having been received at the first communication processor after the storage device becomes the normal state, receives the notification whether the storage device is in the normal state or in the abnormal state from the state acquiring circuit and determines the bridge processor when the storage device is in the abnormal state and determines the cache proxy processor when the storage device is in the normal state.

10. The communication device according to claim 1, further comprising the storage device.

11. The communication device according to claim 2,
wherein the state acquiring circuit acquires information on a reception frequency of the first data transfer request for which the cache proxy processor has been determined by the distribution processor and size information of data requested by the first data transfer request and evaluates the load state of the storage device in accordance with the information and the size information.

12. The communication device according to claim 7,
wherein the state acquiring circuit acquires information on a reception frequency of the first data transfer request for which the cache proxy processor has been determined by the distribution processor and size information of data requested by the first data transfer request and evaluates the load state of the storage device in accordance with the information and the size information.

13. The communication device according to claim 2,
wherein the state acquiring circuit acquires information on a transmission frequency of the second data transfer request and size information of data requested by the second data transfer request and evaluates the load state of the storage device in accordance with the information and the size information.

14. The communication device according to claim 2,
wherein the communication device receives instructions of writing or reading a file for the storage device from an application or a user and performs processing of writing or reading the file for the storage device, and
wherein the state acquiring circuit acquires information on a frequency of the instructions of the writing or the reading for the storage device and size information of the file, and evaluates the load state of the storage device on the basis of the information and the size information.

15. A communication method performed in a communication device including a first communication processor which communicates with a first communication device and a second communication processor which communicates with a second communication processor, comprising:
performing bridge processing which receives a first data transfer request for the second communication device received at the first communication processor to transmit the first data transfer request through the second communication processor, and receives a first response having been received at the second communication processor to transmit the first response through the first communication processor, the first response including data requested by the first data transfer request;
performing cache proxy processing which examines whether the data requested by the first data transfer request is present in a storage device, transmits a second response including the data through the first communication processor when the data is present, transmits a second data transfer request which requests transmission of the data for the second communication device through the second communication processor when the data is not present, stores a data included in a third response for the second data transfer request from the second communication device in the storage device and transmits a fourth response including the data through the first communication processor;
acquiring information indicating a state of the storage device; and
determining, when the first data transfer request is received at the first communication processor, one of the bridge processing and the cache proxy processing in accordance with the state of the storage device,
performing the bridge processing when the bridge processing is determined and performing the cache proxy processing when the cache proxy processing is determined.

16. A non-transitory computer readable medium having a program stored therein which, when executed by a computer including a first communication processor which communicates with a first communication device and a second communication processor which communicates with a second communication device, causes the computer to execute processing comprising:
performing bridge processing which receives a first data transfer request for the second communication device received at the first communication processor to transmit the first data transfer through the second communication processor, and receives a first response having been received at the second communication processor to transmit the first response through the first communication processor, the first response including data requested by the first data transfer request;
performing cache proxy processing which examines whether the data requested by the first data transfer request is present in a storage device, transmits a second response including the data through the first communication processor when the data is present, transmits a second data transfer request which requests transmission of the data for the second communication device through the second communication processor when the data is not present, stores a data included in a third response for the second data transfer request from the second communication device in the storage device and transmits a fourth response including the data through the first communication processor;
acquiring information indicating a state of the storage device; and
determining, when the first data transfer request is received at the first communication processor, one of the bridge processing and the cache proxy processing in accordance with the state of the storage device,
performing the bridge processing when the bridge processing is determined and performing the cache proxy processing when the cache proxy processing is determined.

17. A communication device comprising:
a first communication processor which communicates with a first communication device;
a second communication processor which communicates with a second communication device;
a bridge processor configured to perform bridge processing which receives a first data transfer request for the second communication device received at the first communication processor to transmit the first data transfer through the second communication processor, and receives a first response having been received at the second communication processor to transmit the first response through the first communication processor, the first response including data requested by the first data transfer request;
a cache proxy processor configured to perform proxy processing which examines whether the data requested by the first data transfer request is present in a storage device, transmits a second response including the data through the first communication processor when the data is present, transmits a second data transfer request which requests transmission of the data for the second communication device through the second communication processor when the data is not present, stores a data included in a third response for the second data transfer request from the second communication device in the storage device and transmits a fourth response including the data through the first communication processor;
wherein the first data transfer request is transmitted from the second communication processor when the first data transfer request is received at the first communication processor in a state in which a first access load is applied to the storage device, and
wherein the first data transfer request is not transmitted from the second communication processor when the first data transfer request is received at the first communication processor in a state in which a second access load lower than the first access load is applied to the storage device.
